(19) United States
(12) Patent Application Publication
(10) Pub. No.: US 2026/0125068 A1
(43) Pub. Date: May 7, 2026

(54) DRIVER STATE DETECTION DEVICE, DRIVER STATE DETECTION METHOD, AND STORAGE MEDIUM

(71) Applicant: HONDA MOTOR CO., LTD., Tokyo (JP)

(72) Inventors: Hirotaka Katayama, Tokyo (JP); Yuichi Masukake, Wako-shi (JP); Kazuma Hamada, Tokyo (JP)

(21) Appl. No.: 19/379,942

(22) Filed: Nov. 5, 2025

(30) Foreign Application Priority Data
Nov. 7, 2024 (JP) 2024-195428

(51) Int. Cl. B60W 50/08; B60Q 9/00; B60W 30/02; B60W 30/09; G06V 20/59; G06V 40/18; G07C 5/04

(52) U.S. Cl. CPC B60W 50/087; B60Q 9/00; B60W 30/02; B60W 30/09; G07C 5/04; B60W 2540/30; G06V 20/597; G06V 40/18

(57) ABSTRACT

According to an embodiment, a driver state detection device includes a recognizer configured to recognize a monitoring direction of a driver of a mobile object and a behavior of the mobile object, a determiner configured to determine whether or not the monitoring direction of the driver recognized by the recognizer is appropriate, a counter configured to perform a counting process for a period of time in which the determiner determines that the monitoring direction of the driver is inappropriate, and an alert output configured to output alert information when a count value from the counter is greater than or equal to a threshold. The counter stops the counting process while the recognizer recognizes that the behavior of the mobile object is disturbed or resets the count value when the disturbance in the behavior of the mobile object is recognized.

### CROSS-REFERENCE TO RELATED APPLICATION

Priority is claimed on Japanese Patent Application No. 2024-195428, filed Nov. 7, 2024, the content of which is incorporated herein by reference.

### BACKGROUND

### Field of the Invention

The present invention relates to a driver state detection device, a driver state detection method, and a storage medium.

### Description of Related Art

Recently, efforts to provide access to sustainable transportation systems have been increasingly active in consideration of vulnerable individuals among participants in transportation. For this realization, research and development efforts are focused on further improving the safety and convenience of transportation through research and development related to preventive safety technology. In this regard, conventional technology for performing distraction determination by acquiring a change pattern of first detection information indicating a driver's gaze or face orientation and temporarily switching a normal determination condition set for the distraction determination when the change pattern corresponds to a reference pattern set in advance in accordance with a lane confirmation operation of the driver during a lane change is known (for example, Japanese Unexamined Patent Application, First Publication No. 2019-91275).

### SUMMARY

Meanwhile, in conventional preventive safety technologies, even in behaviors of a mobile object other than lane changes, there are situations in which a driver needs to shift his or her gaze or face orientation to monitor surroundings, but a process for such situations is not taken into account. Therefore, there is a problem because there is a possibility that the driver's state will not be appropriately detected according to the situation of the mobile object.

The present application has been made in consideration of such circumstances and an objective of the present application is to provide a driver state detection device, a driver state detection method, and a storage medium that can enable a state of a driver to be more appropriately detected in accordance with a situation of a mobile object. Also, the present invention contributes to the development of a sustainable transportation system.

A driver state detection device, a driver state detection method, and a storage medium according to the present invention adopt the following configurations.

(1): According to an aspect of the present invention, there is provided a driver state detection device including: a recognizer configured to recognize a monitoring direction of a driver of a mobile object and a behavior of the mobile object; a determiner configured to determine whether or not the monitoring direction of the driver recognized by the recognizer is appropriate; a counter configured to perform a counting process for a period of time in which the determiner determines that the monitoring direction of the driver is inappropriate; and an alert output configured to output alert information when a count value from the counter is greater than or equal to a threshold, wherein the counter stops the counting process while the recognizer recognizes that the behavior of the mobile object is disturbed or resets the count value when the disturbance in the behavior of the mobile object is recognized.

(2): In the above-described aspect (1), the determiner determines whether or not the monitoring direction of the driver is appropriate based on the monitoring direction of the driver and a preset monitoring target area and extends the monitoring target area when the recognizer recognizes that the behavior of the mobile object is disturbed.

(3): In the above-described aspect (1), the counter performs the counting process when it is determined that the monitoring direction is inappropriate even while the recognizer recognizes that the behavior of the mobile object is disturbed and resets the counting process when the disturbance in the behavior has subsided.

(4): In the above-described aspect (3), the alert output suppresses the output of the alert information when the count value is greater than or equal to the threshold while the behavior is disturbed.

(5): In the above-described aspect (3), the counter resets a count value that has been accumulated in the counting process when the recognizer recognizes that the behavior of the mobile object is disturbed and it is determined that the monitoring direction is inappropriate.

(6): In the above-described aspect (5), the counter performs a reset process including a count value that has been accumulated in the counting process before the recognizer recognizes that the behavior of the mobile object is disturbed.

(7): In the above-described aspect (1), the disturbance in the behavior is disturbance in the behavior of the mobile object in a lateral direction.

(8): In the above-described aspect (1), the driver state detection device further includes a movement controller configured to control movement of the mobile object, wherein the recognizer recognizes that the behavior of the mobile object is disturbed when control for stabilizing the behavior of the mobile object is executed by the movement controller.

(9): In the above-described aspect (4), the disturbance in the behavior includes an avoidance operation including lateral movement of the mobile object based on a driving operation of the driver according to an external situation of the mobile object.

(10): According to another aspect of the present invention, there is provided a driver state detection method including: recognizing, by a computer, a monitoring direction of a driver of a mobile object and a behavior of the mobile object; determining, by the computer, whether or not the recognized monitoring direction of the driver is appropriate; performing, by the computer, a counting process for a period of time in which it is determined that the monitoring direction of the driver is inappropriate; outputting, by the computer, alert information when a count value from the counter is greater than or equal to a threshold and stopping, by the computer, the counting process while it is recognized that the behavior of the mobile object is disturbed or resetting the count value when the disturbance in the behavior of the mobile object is recognized.

(11): According to yet another aspect of the present invention, there is provided a computer-readable non-transitory storage medium storing a program for causing a computer to: recognize a monitoring direction of a driver of a mobile object and a behavior of the mobile object; determine whether or not the recognized monitoring direction of the driver is appropriate; perform a counting process for a period of time in which it is determined that the monitoring direction of the driver is inappropriate; output alert information when a count value from the counter is greater than or equal to a threshold; and stop the counting process while it is recognized that the behavior of the mobile object is disturbed or reset the count value when the disturbance in the behavior of the mobile object is recognized.

According to the above-described aspects (1) to (11), it is possible to more appropriately detect a state of a driver in accordance with a situation of a mobile object.

### BRIEF DESCRIPTION OF THE DRAWINGS

FIG. 1 is a configuration diagram of a vehicle system including a driver state detection device according to an embodiment.

FIG. 2 is a diagram showing a relationship between a driver's gaze and a monitoring target area.

FIG. 3 is an explanatory diagram of a relationship between the driver's monitoring direction over time, a count value, and disturbance in a behavior of a vehicle M.

FIG. 4 is a flowchart showing an example of a first process executed by a driving assistance device in an embodiment.

FIG. 5 is a flowchart showing an example of a second process executed by the driving assistance device in an embodiment.

### DESCRIPTION OF EMBODIMENTS

Hereinafter, embodiments of a driver state detection device, a driver state detection method, and a storage medium of the present invention will be described with reference to the drawings. Hereinafter, an example of a mobile object to which the driver state detection device is applied will be described. It is assumed that an example of the mobile object is a vehicle. In addition to the vehicle, the mobile object may include, for example, a watercraft that can move on the ground (on the road) like a hovercraft, an aircraft that can travel on the road, a stand-up vehicle having a motive power unit, micromobility such as an electric scooter, and the like.

### Overall Configuration

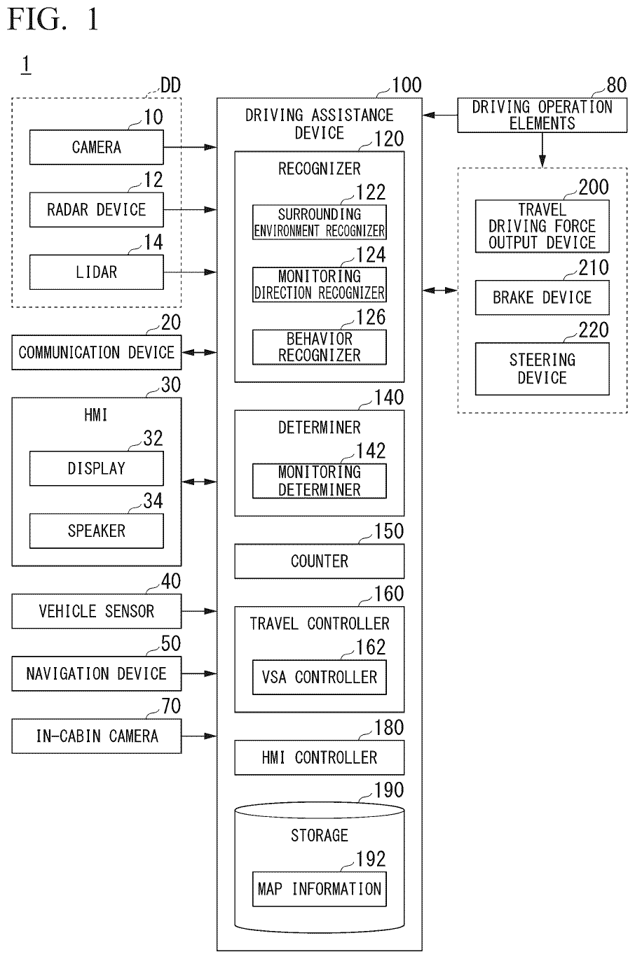

FIG. 1 is a configuration diagram of a vehicle system 1 including the driver state detection device according to the present embodiment. A vehicle (hereinafter referred to as a vehicle M) in which the vehicle system 1 is mounted is, for example, a micromobility or a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a battery (a power storage battery) such as a secondary battery or a fuel cell is discharged.

For example, the vehicle system 1 includes a camera 10, a radar device 12, a light detection and ranging (LIDAR) 14, a communication device 20, a human machine interface (HMI) 30, a vehicle sensor 40, a navigation device 50, an in-cabin camera 70, driving operation elements 80, a driving assistance device 100, a travel driving force output device 200, a brake device 210, and a steering device 220. Such devices and equipment are connected to each other by a multiplex communication line such as a controller area network (CAN) communication line, a serial communication line, a wireless communication network, or the like. The configuration shown in FIG. 1 is merely an example and some of the constituent elements may be omitted or other constituent elements may be further added. A combination of the camera 10, the radar device 12, and the LIDAR 14 is an example of a “detection device DD.” The HMI 30 is an example of an “alerter.”

For example, the camera 10 is a digital camera using a solid-state imaging element such as a charge-coupled device (CCD) or a complementary metal oxide semiconductor (CMOS). The camera 10 is attached to any location on the vehicle M on which the vehicle system 1 is mounted. For example, when the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the sides of the vehicle M are imaged, the camera 10 is attached to left and right door mirrors or the like. For example, the camera 10 periodically and iteratively images the surroundings of the vehicle M. The camera 10 may be a stereo camera.

The radar device 12 radiates radio waves (radar) such as millimeter waves around the vehicle M and detects at least a position of a physical object (a distance from the physical object and a direction of the physical object) by detecting radio waves (reflected waves) reflected by the physical object near the vehicle M. The radar device 12 is attached to any location on the vehicle M. The radar device 12 may detect a position and a speed of the physical object in a frequency-modulated continuous wave (FM-CW) scheme.

The LIDAR 14 radiates light to the vicinity of the vehicle M and measures scattered light. The LIDAR 14 detects a distance from an object on the basis of time from light emission to light reception. The radiated light is, for example, pulsed laser light. The LIDAR 14 is attached to any location on the vehicle M.

The communication device 20, for example, communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the vehicle M and receives input operations from the occupants. The HMI 30 includes, for example, a display 32 and a speaker 34. The display 32 is, for example, a liquid crystal display (LCD), an electro-luminescence (EL) display device, or the like. The display 32 displays various types of images (including videos) in the embodiment. The display 32 may be configured to be integrated with an input as a touch panel. The speaker 34 outputs a predetermined sound (e.g., an alert sound, a message sound, or the like). In addition to (or in place of) the display 32 and the speaker 34, the HMI 30 may include microphones, buzzers, touch panels, switches, keys, and the like. The switches include, for example, a switch for executing or ending predetermined driving control (such as a lane change) executable by a travel controller to be described below, a switch for approving (permitting) or rejecting a driving control recommendation (proposal) from a system (vehicle system 1) side, and the like. The switches may include a switch (turn signal switch) for performing a direction indication operation and the like. The turn signal switch is an example of a “direction indication operator.”

The vehicle sensor 40 includes a vehicle speed sensor configured to detect the speed of the vehicle M, an acceleration sensor configured to detect acceleration, and a yaw rate sensor configured to detect a yaw rate (e.g., a rotational angular velocity around a vertical axis passing through the center of gravity of the vehicle M). The vehicle sensor 40 may include a lateral acceleration sensor (lateral G sensor) that detects the lateral acceleration (lateral G) of the vehicle M, a steering angle sensor that detects a steering angle of the vehicle M (which may be an angle of the steering wheel or an operation angle of the steering wheel), a steering angular velocity sensor that detects a steering angular velocity, a direction sensor that detects an orientation of the vehicle M, and the like.

The vehicle sensor 40 may include a position sensor configured to detect the position of the vehicle M. The position sensor is, for example, a sensor configured to acquire position information (longitude/latitude information) from a Global Positioning System (GPS) device. For example, the position sensor may be a sensor configured to acquire position information using a global navigation satellite system (GNSS) receiver of the navigation device 50. The vehicle sensor 40 may derive the speed of the vehicle M from a position information difference (i.e., a distance) at a predetermined time in the position sensor. A detection result of the vehicle sensor 40 is output to the driving assistance device 100.

For example, the navigation device 50 includes the GNSS receiver, a navigation HMI, and a route decider. The navigation device 50 may store map information in a storage device such as a hard disk drive (HDD) or a flash memory or may acquire map information 192 stored in the storage 190 to be described below. The GNSS receiver identifies a position of the vehicle M on the basis of a signal received from a GNSS satellite. The position of the vehicle M may be identified or complemented by an inertial navigation system (INS) using an output of the vehicle sensor 40. The navigation HMI includes a display device, a speaker, a touch panel, a key, and the like. The GNSS receiver may be provided in the vehicle sensor 40. The navigation HMI may be partly or wholly shared with the above-described HMI 30. For example, the route decider decides a route (hereinafter referred to as a route on a map) from the position of the vehicle M identified by the GNSS receiver (or any input position) to a destination input by the occupant using, for example, the navigation HMI with reference to the map information 192 or the like. The navigation device 50 provides route guidance using the navigation HMI based on the decided route on the map. The navigation device 50 may transmit a current position and a destination to a navigation server via the communication device 20 and acquire a route equivalent to the route on the map from the navigation server.

Here, the map information 192 is, for example, information in which a road shape is expressed by a link indicating a road (an example of a movement path) and nodes connected by the link. The map information 192 may include point of interest (POI) information, and the like. The map information 192 includes, for example, the number of lanes (the number of movement paths), a type and shape of a road marking, information about a center of a lane or information about a road boundary, and the like. The map information 192 may include information about whether the road boundary is a boundary (physical boundary) including a structure through which the vehicle cannot pass (including crossing or contacting). Physical boundaries are, for example, guardrails, curbs, medians, fences, and the like. The map information 192 may include road shape information, traffic regulation information, address information (address and postal code), facility information, parking lot information, phone number information, and the like. The road shape information is information such as the curvature of the road (which may also be expressed as a radius of curvature, and the same applies hereinafter), a width, a road surface gradient, and information about branch points, merging points, intersections, T-junctions, and the like. The map information 192 may be updated from time to time when the communication device 20 communicates with an external device.

The in-cabin camera 70, for example, is a digital camera using a solid-state image sensor such as a CCD and CMOS. The in-cabin camera 70 is mounted at any location in the vehicle M in a position and orientation that allow the head of the driver sitting in the driver's seat of the vehicle M to be imaged from the front. For example, the in-cabin camera 70 is mounted on top of the display device located in the center of the instrument panel of the vehicle M. The in-cabin camera 70 may image the interior of the vehicle in the area including the occupant (passenger) sitting in a passenger seat of the vehicle M. The in-cabin camera 70 can also image a cabin by radiating infrared light towards the cabin. The in-cabin camera 70, for example, periodically and iteratively images the cabin.

The driving operation elements 80 include, for example, a steering wheel, an accelerator pedal, and a brake pedal. The driving operation elements 80 may also include a shift lever, a variant steering wheel, a joystick, and other operation elements. For example, an operation detector configured to detect an amount of operation on the operation element by the driver or the presence or absence of operation is attached to each operation element of the driving operation elements 80. The operation detector detects, for example, a steering angle and steering torque of the steering wheel (e.g., an amount of steering based on a driving operation of the driver (steering input torque)), a steering torque variation rate, an amount of depression of the accelerator pedal or the brake pedal, and the like. Also, the operation detector outputs the detection result to the driving assistance device 100, or to one or all of the travel driving force output device 200, the brake device 210, and the steering device 220. The driving operation element 80 may include a direction indication operator (e.g., a turn signal lever (turn lever) or a turn signal switch). When the direction indication operator has been operated, a turn signal (direction indicator) of the vehicle M associated with the operation content blinks, and the operation content (e.g., including a result of detecting an operation performed by the driver) is output to the driving assistance device 100.

The driving assistance device 100 executes various types of control for supporting the driving of the driver of the vehicle M. The driving assistance device 100 includes, for example, a recognizer 120, a determiner 140, a counter 150, a travel controller 160, an HMI controller 180, and a storage 190. Each of the recognizer 120, the determiner 140, the counter 150, the travel controller 160, and the HMI controller 180 is implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as an HDD or a flash memory of the driving assistance device 100 or may be stored in a removable storage medium such as a DVD, a CD-ROM, or a memory card and installed in the storage device of the driving assistance device 100 when the storage medium (the non-transitory storage medium) is mounted in a drive device, a card slot, or the like. The driving assistance device 100 is an example of a “driver state detection device.” The travel controller 160 is an example of a “movement controller.” The HMI 30 and HMI controller 180 are examples of an “alert output.” The storage 190 may be implemented by the above-described various storage devices, an electrically erasable programmable read-only memory (EEPROM), a read-only memory (ROM), a random-access memory (RAM), or the like. The storage 190 stores, for example, map information 192, various information in embodiments, programs, and the like. The storage 190 may store various types of setting information for use in the process in the present embodiment.

The recognizer 120, for example, includes a surrounding environment recognizer 122, a monitoring direction recognizer 124, and a behavior recognizer 126. The surrounding environment recognizer 122 recognizes a surrounding situation of the vehicle M, for example, based on a detection result of the detection device DD (information input from the camera 10, the radar device 12, and the LIDAR 14). For example, the surrounding environment recognizer 122 performs a sensor fusion process on some or all of the detection results of the camera 10, the radar device 12, and the LIDAR 14 to recognize the position (relative position), size, speed (relative speed), acceleration, and the like of a physical object located in the vicinity of the vehicle M (within a predetermined distance). Physical objects recognized by the surrounding environment recognizer 122 may include, for example, traffic participants (examples of obstacles) such as other vehicles, pedestrians, bicycles, and the like in addition to physical boundaries that divide the road (movement path). The position of the physical object, for example, is recognized as a position on absolute coordinates with a representative point (the center of gravity, the center of drive shaft, or the like) of the vehicle M as the origin, and is used for control. The position of the physical object may be indicated by a representative point such as the center of gravity or a corner of the physical object or may be indicated by an area that has been represented. The “state” of the physical object may include, for example, the acceleration or jerk of another vehicle, or the “action state” (e.g., whether or not the other vehicle is changing lanes or is about to change lanes) when the physical object is the other vehicle.

The surrounding environment recognizer 122 may recognize, for example, a stop line, a red light, a toll booth, other road events, road signs, and markings drawn on the road (e.g., speed limits), and the like. The surrounding environment recognizer 122 may recognize the curvature of a travel lane (travel road) of the vehicle M based on the detection results of the detection device DD or the map information 192. The surrounding environment recognizer 122 may recognize a road surface situation (e.g., whether the road surface is slippery, such as freezing of the road surface) and the like based on the detection result of the detection device DD.

The surrounding environment recognizer 122 recognizes, for example, a lane in which the vehicle M is traveling (travel lane), other lanes located in a nearby area (e.g., adjacent lanes), and the like. For example, the surrounding environment recognizer 122 recognizes a road marking from the image captured by the camera 10, and recognizes the travel lane and other lanes based on a positional relationship of the recognized road markings seen from the vehicle M. The surrounding environment recognizer 122 may recognize the lane in which the vehicle M is traveling or other lanes with reference to the map information 192 based on the position information of the vehicle M obtained from the vehicle sensor 40 and the like.

The monitoring direction recognizer 124 recognizes a state of an occupant of the vehicle M using an image captured by the in-cabin camera 70. For example, the monitoring direction recognizer 124 performs a known image analysis process on the image captured by the in-cabin camera 70, and recognizes a monitoring direction of the driver of the vehicle M based on an analysis result. The monitoring direction includes, for example, at least one of the driver's gaze (a direction in which the driver is looking) and the orientation of the driver's face.

For example, the monitoring direction recognizer 124 detects a combination of the driver's eye reference point (a part where the eye does not move) and a moving point (a moving part of the eye) from the image using a method such as template matching. The combination of the reference point and the moving point is, for example, a combination of the inner canthus of the eye and the iris, a combination of the corneal reflection area and the pupil, or the like. The corneal reflection area is an area of reflection of infrared light in the cornea, for example, when the in-cabin camera 70 radiates infrared light towards the driver. Also, the monitoring direction recognizer 124 recognizes the driver's gaze by performing coordinate conversion from an image plane into an actual space and the like based on the position of the moving point relative to the reference point. The monitoring direction recognizer 124 recognizes the orientation of the driver's face based on position information about the eyes, nose, mouth, and the like in the facial area obtained from the image analysis results (relative position information of each part and the like).

The monitoring direction recognizer 124 may recognize a shape of the driver's eyes from a result of analyzing the image of the in-cabin camera 70 and may recognize that the driver is wearing sunglasses or glasses according to template matching or the like. The monitoring direction recognizer 124 may determine whether the driver is monitoring the surroundings of the vehicle M based on the driver's gaze or face orientation. The monitoring direction recognizer 124 may recognize the driver's posture (movement) and an amount of change (an amount of motion) at a given time.

For the recognition of information using the above-described images, for example, a trained model trained by machine learning or the like may be used in advance. In this case, the monitoring direction recognizer 124 inputs the image of the in-cabin camera 70 to the trained model using the image as an input and using the gaze or face orientation of the person included in the image as an output, and acquires the driver's gaze or face orientation.

The behavior recognizer 126 recognizes a behavior of the vehicle M based on a detection result of the vehicle sensor 40, a detection result of the operation detector of the driving operation element 80, content of control executed by the travel controller 160, and the like. The behavior of the vehicle M includes a behavior based on manual driving of the driver and a behavior based on driving control executed by the travel controller 160. The behavior recognizer 126 may recognize a disturbance in the behavior of the vehicle M. Behavior disturbances are, for example, behavior disturbances in which an amount of change in the lateral position of the vehicle M or the orientation of the vehicle M at a given time is greater than or equal to a threshold. Behavior disturbances may include, for example, the lateral slip of the vehicle M and the like. The lateral slip is a disturbance in the behavior in which the front or rear wheels of the vehicle M drift outward due to a steering operation, for example, when the vehicle M cannot turn while traveling on a curved road or the like, or the driver performs a sudden steering operation, or a steering operation in a situation in which the road surface is frozen. For example, behavior disturbances may include disturbances in the lateral behavior of the vehicle, and an avoidance operation including lateral movement of the vehicle M by the driver's driving operation (manual driving) according to an external situation of the vehicle M (e.g., obstacle approach and the like).

For example, the behavior recognizer 126 recognizes a lateral position of the vehicle M relative to the travel lane (a position in the lane width direction) and a posture (orientation) of the vehicle M relative to an extension direction of the travel lane based on a positional relationship of the vehicle M relative to the travel lane. For example, the behavior recognizer 126 may recognize a deviation of a reference point of the vehicle M from the center of the lane and an angle formed between the travel direction of the vehicle M and a line connected to the center of the lane as a relative position and orientation of the vehicle M related to the travel lane. Alternatively, the behavior recognizer 126 may recognize a position of the reference point of the vehicle M related to one side end portion (a road marking or a road boundary) of the travel lane or the like as a relative position (lateral position) of the vehicle M related to the travel lane. The behavior recognizer 126 may recognize the lateral behavior of the vehicle M (e.g., whether or not there has been lateral movement of a predetermined distance or more at a given time) from an amount of change in the lateral position of the vehicle M and the direction (yaw rate) of the vehicle M described above or may recognize that the behavior is disturbed when the amount of change is greater than or equal to a predetermined amount.

The behavior recognizer 126 may detect the behavior of the vehicle M from an amount of operation of the steering wheel obtained by the operation detector (e.g., a steering angle, a steering torque, a steering torque change rate, or the like), amounts of depression of the accelerator pedal and the brake pedal, and the like when the vehicle M is executing the manual driving or may recognize behavior disturbances from the amount of change in behavior at a given time. The behavior recognizer 126 may recognize a disturbance in the behavior of the vehicle M, such as lateral slip, when the actual yaw rate or lateral acceleration of the vehicle M exceeds the yaw rate or lateral acceleration set in advance corresponding to the operation amount (or when it exceeds a predetermined allowable range) by comparing the operation amount of the steering wheel detected by the operation detector with the yaw rate or lateral acceleration (lateral G) of the vehicle M obtained from the vehicle sensor 40.

The behavior recognizer 126 may recognize the behavior of the vehicle M based on the content of the driving control executed by the travel controller 160. The driving control is control for causing the vehicle M to travel by controlling at least one of the steering and the speed of the vehicle M, regardless of the driving operation from the driver or by receiving only a partial instruction. Driving control includes, for example, an adaptive cruise control system (ACC), a lane keeping assistance system (LKAS), auto lane changing (ALC), and the like. The driving control may include control for stopping the vehicle M at a safe location such as a shoulder based on a determination result of the determiner 140, and control for controlling steering or speed to avoid contact between the vehicle M and an obstacle recognized by the surrounding environment recognizer 122. The driving control includes, for example, vehicle stability assist (VSA). The VSA is a system for automatically stabilizing the behavior of the vehicle M when slip of the vehicle M or the like is occurring. The VSA may include, for example, an anti-lock braking system (ABS) for reducing slip caused by wheel lock during sudden deceleration or deceleration on a low-friction road surface, a traction control system (TCS) for preventing wheel slip during start or acceleration, a safety device such as a device for suppressing lateral slip, a system that integrally controls these safety devices, or the like. For example, the behavior recognizer 126 recognizes the behavior of the vehicle M by the execution of LKAS, ALC, or the like by the travel controller 160. The behavior recognizer 126 may recognize that the behavior of the vehicle M is disturbed when the VSA based on the travel controller 160 is in execution.

The determiner 140 includes, for example, a monitoring determiner 142. The monitoring determiner 142 determines whether or not the driver's monitoring direction is appropriate based on at least one of the driver's gaze and face orientation recognized by the monitoring direction recognizer 124 and a preset monitoring target area.

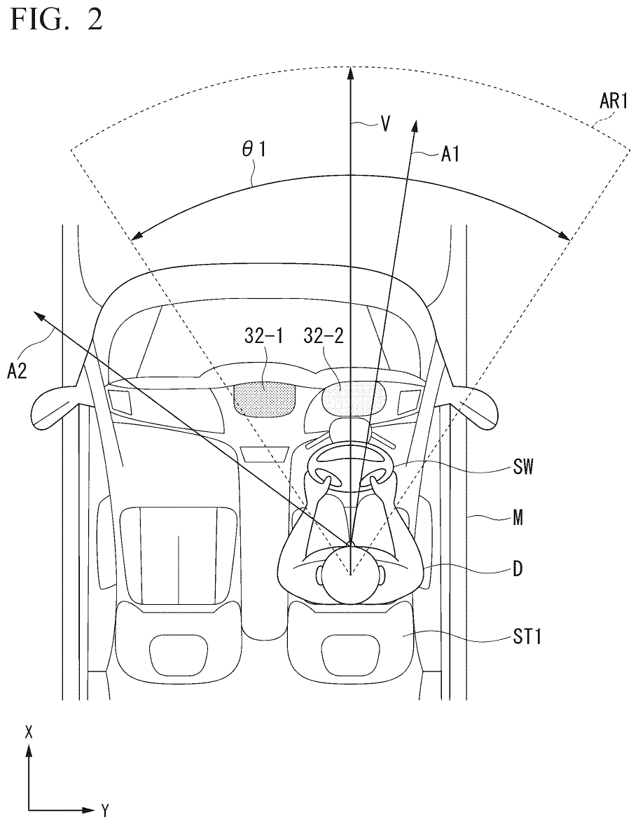

FIG. 2 is a diagram showing a relationship between the driver's gaze and the monitoring target area. In the example in FIG. 2, a state in which the driver D sits in the driver's seat ST1 of the vehicle M, and the driver D operates the driving operation element 80 such as a steering wheel SW to perform manual driving for the vehicle M is schematically shown. In the example in FIG. 2, displays 32-1 and 32-2 included in the HMI 30 are shown. For example, when the vehicle M is traveling in a straight-ahead direction (X-axis direction in the drawing), the monitoring determiner 142 sets a monitoring target area AR1 having a predetermined angle to the left and right based on the travel direction V of the vehicle M from the head position of the driver D, as shown in FIG. 2.

The monitoring target area AR1 may be adjusted in accordance with the speed of the vehicle M, the shape of the road, the recognition result of the recognizer 120, or the like. In this case, for example, an angle (radians) θ1, which indicates a size of the arc of the monitoring target area, may be set to a small angle in accordance with a magnitude of the speed, or the angle θ1 may be set to a larger angle as the width of the road increases. In the monitoring target area AR1, the current area is rotationally shifted to the right using the position of the driver D's head as the center when the vehicle M performs a lane change from the travel lane to the right adjacent lane and the current area is rotationally shifted to the left using the position of the driver D's head as the center when the vehicle M performs the lane change from the travel lane to the left adjacent lane. In this case, the magnitude of the angle θ1 can also be changed. Also, if the vehicle M turns right or left, the area of the monitoring target area AR1 can be similarly changed. In the monitoring target area AR1, the area may be expanded when the behavior recognizer 126 recognizes that the behavior of the vehicle M is disturbed.

In this situation, the monitoring determiner 142 determines that the monitoring direction of the driver D is appropriate when the gaze of the driver D recognized by the recognizer 120 is within the angle θ1 of the monitoring target area AR1 (or when a state in which the gaze of the driver D is located within the angle θ1 continues for a predetermined period of time or more) and determines that the monitoring direction of the driver D is inappropriate when the gaze is not within the angle θ1 (or when a state in which the gaze of the driver D is not located within the angle θ1 continues for the predetermined period of time or more). In the example of FIG. 2, it is determined that the monitoring direction of the driver D is appropriate when the gaze of the driver D is a gaze A1 and it is determined that the monitoring direction of the driver D is inappropriate when the gaze of the driver D is a gaze A2.

The monitoring determiner 142 may determine whether or not the monitoring direction of the driver D is appropriate by comparing the orientation of the head of the driver D recognized by the recognizer 120 with the monitoring target area AR1 instead of (or in addition to) the gaze of the driver D. For example, the monitoring determiner 142 performs the above-described determination based on at least the gaze and the monitoring target area AR1 when the gaze of the driver D is recognized by the monitoring direction recognizer 124 and performs the above-described determination using the orientation of the face of the driver D when the driver D is wearing sunglasses or glasses and the gaze is not recognized and when the orientation of the face is recognized.

Returning to FIG. 1, the counter 150 performs a counting process for a period of time when it is determined that the monitoring direction of the driver D is inappropriate by the monitoring determiner 142. The counter 150 may stop the counting process while the behavior of the vehicle M is disturbed. The counter 150 can reset (initialize) at least a part of a value (count value) accumulated in a counting process so far in the event of a disturbed behavior of the vehicle M. The counter 150 may count the time when the monitoring determiner 142 determines that the monitoring direction of the driver D is appropriate. Details of the functions of the counter 150 will be described below.

The travel controller 160 controls the movement of the vehicle M (movement of the mobile object). For example, the travel controller 160 executes driving control for the vehicle M based on the recognition result of the recognizer 120, the determination result of the determiner 140, or the like. The driving control may be executed by receiving an execution instruction from the driver D via the HMI 30 or may be executed independently of the driver D's instruction based on the recognition result of the recognizer 120. When the driving control is executed, the travel controller 160 generates a future target trajectory of the vehicle M according to the content of the driving control based on the recognition result of the recognizer 120, and controls at least one of the steering and speed of the vehicle M so that the vehicle M travels according to the generated target trajectory.

For example, the travel controller 160 includes a VSA controller 162. The VSA controller 162 executes control (e.g., VSA) for automatically stabilizing the behavior of the vehicle M when the behavior recognizer 126 recognizes that the behavior of the vehicle M is disturbed. The VSA, for example, is executed continuously until the change in the behavior (lateral behavior) of the vehicle M is less than or equal to a predetermined value. The travel controller 160 performs the driving control of ACC, LKAS, ALC, or the like in addition to the control process of the VSA controller 162. The travel controller 160 may perform a process for controlling the vehicle M so that the vehicle M stops at a safe position such as the shoulder of the road or the like when the driver's monitoring direction has not improved even after the elapse of a predetermined time or more from the output of alert information indicating that the driver's monitoring direction is inappropriate or the like by the HMI controller 180.

The HMI controller 180 notifies occupants (including the driver D) of predetermined information using the HMI 30 or receives information input by the HMI 30. The predetermined information includes, for example, information related to the travel of the vehicle M, such as information about the state of the vehicle M and information about the driving control. The information about the state of the vehicle M includes, for example, the vehicle M's speed, engine speed, and shift position and the like. The information about the driving control includes, for example, whether or not the driving control has been executed by the travel controller 160, information about an execution situation of the driving control, information about the recommendation (proposal) of the driving control from the system side, alert information for the driver D, and the like. The predetermined information may include information about the surrounding situation recognized by the detection device DD. The predetermined information may include information that is not related to the travel of the vehicle M, such as TV programs and content (e.g., videos) stored in storage media such as DVDs. The predetermined information may include, for example, information about a current position and destination of the vehicle M, and the remaining fuel level of the vehicle M. The HMI controller 180 may output the information received by the HMI 30 to the communication device 20, the recognizer 120, the determiner 140, the navigation device 50, or the like.

The HMI controller 180 may output inquiry information for the occupant, the recognition result of the recognizer 120, the determination result of the determiner 140, and the like to the HMI 30. The HMI controller 180 may transmit various types of information to be output to the HMI 30 to the terminal device used by the occupant of the vehicle M via the communication device 20.

For example, the HMI controller 180 generates alert information (an image, a vocal sound, or the like) about the monitoring of the driver D when the count value from the counter 150 is greater than or equal to the threshold, and outputs the generated alert information to the HMI 30 (a display 32-1, a display 32-2, a speaker 34, and the like) to provide a notification to the driver D. The alert information includes, for example, information for notifying that the monitoring direction is inappropriate, information for providing a notification of the correct monitoring direction (e.g., the monitoring target area AR1). The alert information may include information about the count value counted by the counter 150, information indicating that the count has been stopped, or information indicating that the count has been reset. Thereby, it is possible to allow the driver D or the like to ascertain the control state on the system side more accurately.

For example, the HMI controller 180 may output alert information until the monitoring determiner 142 determines that the monitoring direction of the driver D is appropriate or may output alert information until the time when the monitoring direction of the driver D is determined to be appropriate by the counter 150 is greater than or equal to a predetermined time.

The travel driving force output device 200 outputs a travel driving force (torque) for enabling the vehicle M to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the travel controller 160 or information input from the accelerator pedal of the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the travel controller 160 or the information input from the brake pedal of the driving operation element 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the travel controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the travel controller 160 or the information input from the steering wheel of the driving operation element 80 to change the direction of the steerable wheels.

### Counter

Next, details of the functions of the counter 150 will be described. The counter 150 performs a counting process for the time when the monitoring determiner 142 determines that the monitoring direction of the driver D is inappropriate. For example, the monitoring determination of the monitoring determiner 142 is iteratively executed at predetermined intervals. Therefore, the counter 150 can calculate the time (period) based on the accumulated count by incrementing the count value by 1 every time the driver D's monitoring direction is determined to be inappropriate at predetermined intervals. The count value may be continuously incremented while it is continuously determined that the driver D's monitoring direction is inappropriate and may be reset when it is determined that the driver D's monitoring direction is appropriate (or when a predetermined time has elapsed after the determination of the appropriate monitoring direction).

Here, when the behavior of the vehicle M is disturbed, the driver D is likely to move his or her gaze or face orientation to look around the surroundings of the vehicle M. In this case, the driver D's gaze is not located in the monitoring target area AR1, but it is not desirable for the above-described alert information to be output. Therefore, the counter 150 stops a counting process while the behavior recognizer 126 recognizes that the behavior of the vehicle M is disturbed.

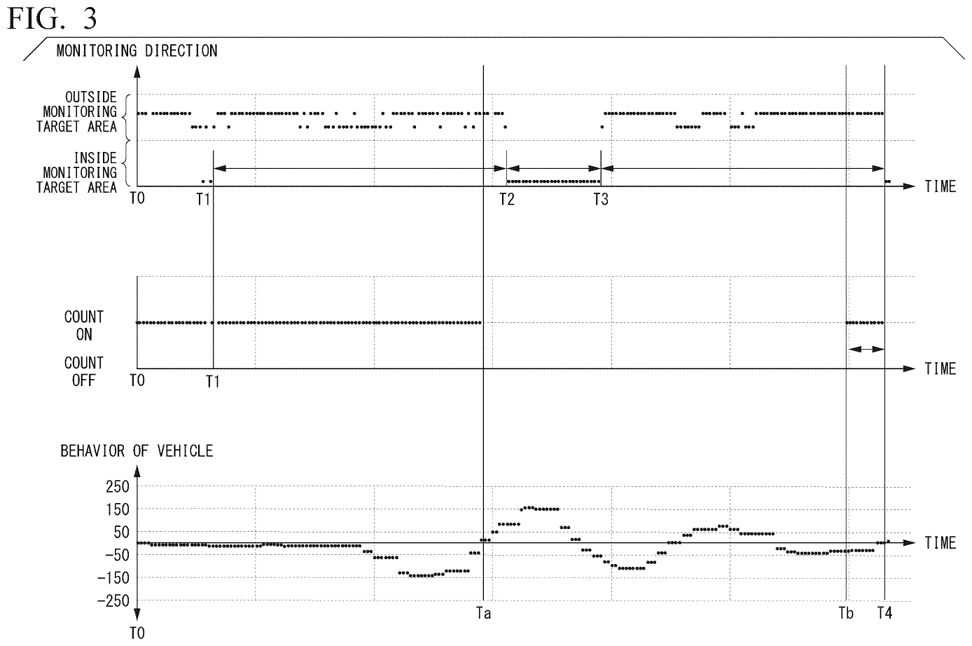

FIG. 3 is an explanatory diagram of a relationship between the driver's monitoring direction over time, the count value, and the disturbance in the behavior of the vehicle M. In the example in FIG. 3, the horizontal axis represents time and the vertical axis represents a monitoring direction of the driver D, ON/OFF of the counting process of the counter 150, and a vehicle behavior (e.g., a yaw rate, a steering angle, or the like). As the sign for the vehicle behavior, plus (+) indicates one of the left and right with respect to the reference direction (0) and minus (−) indicates the other. In the example of FIG. 3, time T0 to T4 is a period of time that has elapsed sequentially from time T0 to time T4. Plot points shown in FIG. 3 indicate the driver's monitoring direction (the top drawing of FIG. 3), a count value (the middle drawing of FIG. 3), and a steering angle value (the bottom drawing of FIG. 3) detected at predetermined intervals.

For example, in FIG. 3, at least a period of time T1 to T2 and T3 to T4 is a period (time) during which the monitoring direction of the driver D is located outside the monitoring target area and the monitoring direction of the driver D is determined to be inappropriate by the monitoring determiner 142 (time T0 to T1 also includes a period during which the monitoring direction of the driver D is located outside the monitoring target area, but the description is omitted for the convenience of description). Time T2 to T3 is a period (time) during which the monitoring direction of the driver D is located in the monitoring target area and the monitoring direction of the driver D is determined to be appropriate by the monitoring determiner 142. For example, the HMI controller 180 outputs alert information about the monitoring of the driver D when a count value accumulated in the counting process from time T1 is greater than or equal to the threshold.

Here, as shown in FIG. 3, if the behavior recognizer 126 recognizes that the behavior of the vehicle M is disturbed after time T1 and at time Ta before the count value is greater than or equal to the threshold, the counter 150 stops a time counting process. For example, the counter 150 stops a process for counting the time during which the monitoring determiner 142 determines that the monitoring direction of the driver D is inappropriate during a period from time Ta to time Tb when it is recognized that the behavior of the vehicle M is not disturbed (the disturbance of the vehicle M's behavior converges to a predetermined level or less). Therefore, because the count value is not incremented even if the monitoring direction of the driver D is located outside the monitoring target area during the period of time Ta to Tb, the count value is not greater than or equal to the threshold and the alert information is not output. Therefore, even if the behavior of the vehicle M is disturbed and the driver D is distracted to check the situation, it is possible to suppress the output of the alert information without determining that the driver D is distracted.

After time Tb when it is not recognized that the behavior of the vehicle M is disturbed (i.e., it is recognized that the behavior of the vehicle M is not disturbed) from the time Ta, if the monitoring direction of the driver D is outside the monitoring target area and the monitoring determiner 142 determines that the monitoring direction of the driver D is inappropriate, the counter 150 continues the counting process from the count value up to the time Ta. When the count value is greater than or equal to the threshold, the HMI controller 180 outputs alert information. Thereby, it is possible to more appropriately detect the state of the driver in accordance with a situation of the vehicle M. In accordance with a detection result, appropriate control (e.g., alert control or travel control) can be executed.

In the example of FIG. 3, when it is recognized that the behavior of the vehicle M is disturbed, even if the monitoring direction of the driver D is located within the monitoring target area and the monitoring determiner 142 determines that the monitoring direction of the driver D is appropriate (e.g., when there is a period from time T2 to time T3 of FIG. 3), because the monitoring direction is not necessarily the correct monitoring direction in a situation in which the behavior of the vehicle M is disturbed, the count value may not be reset.

### Modification Example

Time Ta of FIG. 3 of the embodiment may be the time when VSA control (control for stabilizing the behavior of the vehicle M) is executed by the VSA controller 162 of the travel controller 160 or time Tb may be the time when the VSA control ends. Therefore, the counter 150 may stop the counting process while the VSA control is in execution or the count value may be reset at the time when the VSA control starts or the VSA control ends.

In the embodiment, instead of stopping the counting process while the behavior recognizer 126 recognizes that the behavior of the vehicle M is disturbed as described above, the counter 150 may reset the count value when a disturbance in the behavior of the vehicle M is recognized. In this case, the counter 150 may reset the count value at time Ta when it is recognized that the behavior of the vehicle M is disturbed or may reset the count value at the time when the disturbance in the behavior of the vehicle M has subsided to a predetermined level or less (the time when time Tb has been reached) (including the count value accumulated up to time Ta).

For example, even while the behavior recognizer 126 recognizes that the behavior of the vehicle M is disturbed, the counter 150 may count the time when the monitoring determiner 142 determines that the driver's monitoring direction is inappropriate (e.g., during a period from time Ta to time T2 and a period from time T3 to time Tb in FIG. 3), and may reset the count value when the disturbance in the behavior of the vehicle M has subsided (when time Tb has been reached). In this case, the HMI controller 180 suppresses the output of alert information even if the count value is greater than or equal to the threshold while it is recognized that the behavior of the vehicle M is disturbed. Suppression may mean either that no alert information is output or that information with a reduced alert degree compared to usual is output. The fact that information with a reduced alert degree is output means, for example, that an alert sound at a lower volume than usual is output, that a message image is displayed in a simpler form than usual, or the like.

If the count value is reset, the counter 150 may reset a count value that has been accumulated in the counting process when the behavior recognizer 126 recognizes that the behavior of the vehicle M is disturbed and the monitoring determiner 142 determines that the monitoring direction of the driver D is inappropriate.

In the above-described embodiment, when the monitoring determiner 142 may determine whether or not the monitoring direction of the driver D is appropriate based on the monitoring direction of the driver D and a preset monitoring target area and when the behavior recognizer 126 recognizes that the behavior of the vehicle M is disturbed, the monitoring target area may be extended. The fact that the monitoring target area is extended is, for example, that the angle θ1 shown in FIG. 2 is increased. Thereby, because it is difficult to determine that the monitoring direction of the driver D is inappropriate, the time counting process of the counter 150 can be stopped.

In the embodiment, the monitoring determiner 142 may perform the distraction determination of whether or not the driver D is distracted instead of determining whether or not the monitoring direction of the driver D is appropriate. In this case, the monitoring determiner 142 determines that the driver D is distracted when the monitoring direction of the driver D is not located in the monitoring target area, and the counter 150 performs a counting process for the time when it is determined that the driver D is distracted.

### Processing Flow

Hereinafter, a process performed by the driving assistance device 100 of the embodiment will be described. Hereinafter, a process related to the alarm output control according to a state of the driver D among processes performed by the driving assistance device 100 will be mainly described. Hereinafter, two different processes will be described.

### First Process

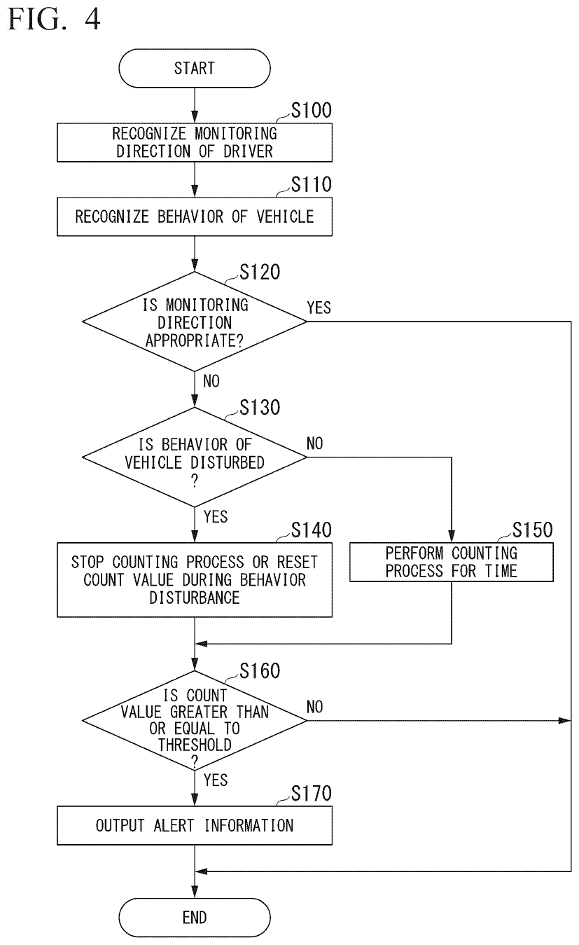

FIG. 4 is a flowchart showing an example of a first process performed by the driving assistance device 100 in the embodiment. The process shown in FIG. 4 can be performed iteratively at predetermined timings or intervals.

In the example of FIG. 4, the monitoring direction recognizer 124 recognizes a monitoring direction (at least one of a gaze and face orientation) of the driver D of the vehicle M (step S100). Subsequently, the behavior recognizer 126 recognizes a behavior of the vehicle M (step S110). Subsequently, the monitoring determiner 142 determines whether or not the monitoring direction of the driver D is appropriate (step S120). When it is determined that the monitoring direction of the driver D is inappropriate, the counter 150 determines whether the behavior of the vehicle M is disturbed based on a recognition result of the behavior recognizer 126 (step S130). When it is determined that the behavior of the vehicle M is disturbed, the counter 150 stops the counting process or resets the count value while the behavior is disturbed (step S140). When it is determined that the behavior of the vehicle M is not disturbed by the processing of step S130, the counter 150 performs a counting process for the time when the monitoring direction of the driver D is inappropriate (step S150).

Subsequently, the HMI controller 180 determines whether or not the count value counted by the counter 150 is greater than or equal to the threshold (step S160). When it is determined that the count value is greater than or equal to the threshold, the HMI controller 180 generates alert information and causes the HMI 30 to output the alert information (step S170). When it is determined that the count value is not greater than or equal to the threshold in the processing of step S160, the process of the present flowchart ends. When it is determined that the monitoring direction of the driver D is appropriate in the processing of step S120, the process of the present flowchart ends.

### Second Process

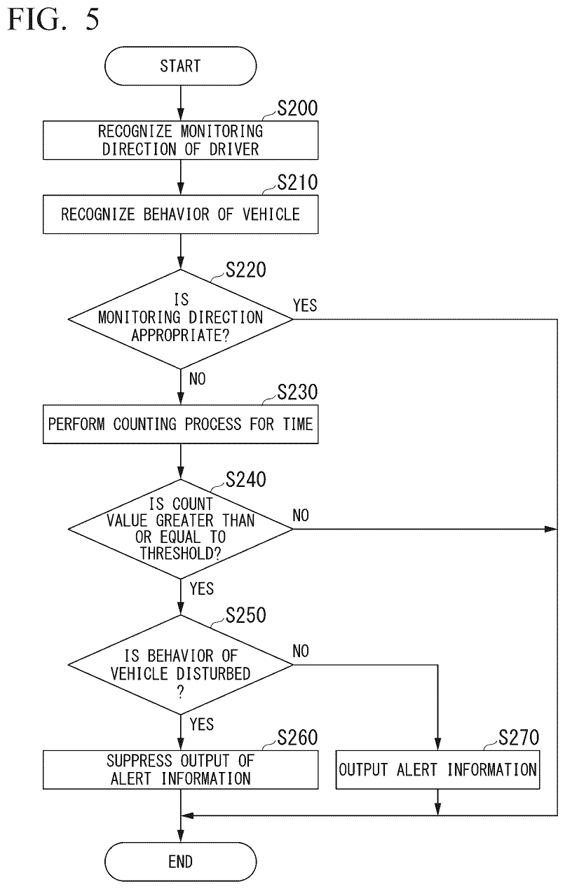

Next, a second process will be described. The second process suppresses an alert output when it is recognized that the behavior of the vehicle M is disturbed, even if the count value of the counter 150 is greater than or equal to the threshold. FIG. 5 is a flowchart showing an example of the second process performed by the driving assistance device 100 in the embodiment. The process shown in FIG. 5 can be iteratively performed at predetermined timings or intervals.

In the example of FIG. 5, the monitoring direction recognizer 124 recognizes a monitoring direction (at least one of a gaze and face orientation) of the driver D of the vehicle M (step S200). Subsequently, the behavior recognizer 126 recognizes a behavior of the vehicle M (step S210). Subsequently, the monitoring determiner 142 determines whether or not the monitoring direction of the driver D is appropriate (step S220). When it is determined that the monitoring direction is inappropriate, the counter 150 performs a counting process for the time (step S230).

Subsequently, the HMI controller 180 determines whether or not a count value accumulated in the counting process of the counter 150 is greater than or equal to a threshold (step S240). When it is determined that the count value is greater than or equal to the threshold, the HMI controller 180 determines whether or not the behavior of the vehicle M is disturbed according to a recognition result of the behavior recognizer 126 (step S250). When it is determined that the behavior of the vehicle M is disturbed, the HMI controller 180 suppresses an output of alert information (step S260). When it is determined that the behavior of the vehicle M is not disturbed in the processing of step S250, the HMI controller 180 generates the alert information and causes the HMI 30 to output the alert information (step S270). Thereby, the present flowchart ends. When it is determined that the monitoring direction is appropriate in the processing of step S220 or when it is determined that the count value is not greater than or equal to the threshold in the processing of step S240, the process of the present flowchart ends.

One of the first and second processes described above may be a combination of parts of the other process. In the second process, when the disturbance in the behavior of the vehicle M converges, the count value may be reset.

According to the embodiment described above, a driver state detection device includes the recognizer 120 configured to recognize a monitoring direction of a driver of the vehicle M (an example of a mobile object) and a behavior of the vehicle M; the determiner 140 configured to determine whether or not the monitoring direction of the driver recognized by the recognizer 120 is appropriate; the counter 150 configured to perform a counting process for a period of time in which the determiner 140 determines that the monitoring direction of the driver is inappropriate; and an alert output (the HMI 30 or the HMI controller 180) configured to output alert information when a count value from the counter 150 is greater than or equal to a threshold, wherein the counter 150 stops a counting process while the recognizer 120 recognizes that the behavior of the vehicle M is disturbed or resets the count value when the disturbance in the behavior of the vehicle M is recognized, whereby it is possible to detect the state of the driver more appropriately in accordance with a situation of the vehicle M. Therefore, alert information can be output at an appropriate time depending on the occupant of the vehicle M, and more appropriate driving control can be performed for the vehicle M.

For example, according to the embodiment, because a count value for outputting an alert to the driver for the disturbances in the behavior of the vehicle M is adjusted, the output of the alert can be suppressed, for example, during the execution of VSA control or immediately after the end of VSA control. According to the embodiment, for example, when the behavior of the vehicle M is disturbed, the driver D may need to check the surroundings even in directions other than a front direction to perform corrective steering or the like, and it is possible to suppress regarding checking the surroundings during the behavior disturbance as distraction and to suppress the annoyance of an alert being output immediately after the behavior disturbance subsides by performing a count stopping process or a count reset process. According to the embodiment, even if the counting process is performed because it is determined that the monitoring direction is inappropriate while the behavior is disturbed, the annoyance such as the alert being output immediately after the behavior disturbance subsides can be suppressed by performing the count reset process when the behavior disturbance has subsided or the like. The process can be simplified because there is no need to change the monitoring target area or change a process of the counter when the behavior is disturbed.

According to the embodiment, even if the counting process itself continues, because the alert output can be suppressed even if the count is greater than or equal to a predetermined level while the behavior is disturbed, the annoyance of an alert output at an unnecessary timing can be suppressed. According to the embodiment, by resetting a count value that has been accumulated in the counting process while the behavior is disturbed, excessive suppression of the alert output can be suppressed, alerts can be output at a more appropriate timing according to the driver's state. According to the embodiment, by performing a reset process (or a total reset process) including a value that has been accumulated in the counting process before the behavior is disturbed, it is possible to suppress the alert output in a short time after the behavior of the vehicle M becomes normal.

In embodiment, the behavior disturbance may include a disturbance in the lateral behavior of the vehicle M. For example, when the behavior is disturbed by slipping in the forward and backward directions, because it is not necessary to check the surroundings, it is possible to output an alert at a more appropriate time by adjusting the count for lateral behavior disturbances that require corrective steering. In the embodiment, the behavior disturbance may include lateral avoidance actions (manual driving) by the driver D according to an external situation. For example, when an avoidance action is performed to avoid an obstacle or the like, because the driver D will visually recognize a direction in which the obstacle is located, it is possible to suppress the alert of such a visual recognition operation as the distraction.

The embodiment described above can be represented as follows.

A driver state detection device including:
a storage medium storing computer-readable instructions; and
a processor connected to the storage medium, the processor executing the computer-readable instructions to:
recognize a monitoring direction of a driver of a mobile object and a behavior of the mobile object;
determine whether or not the recognized monitoring direction of the driver is appropriate;
perform a counting process for a period of time in which it is determined that the monitoring direction of the driver is inappropriate;
output alert information when a count value from the counter is greater than or equal to a threshold; and
stop the counting process while it is recognized that the behavior of the mobile object is disturbed or reset the count value when the disturbance in the behavior of the mobile object is recognized.

Although modes for carrying out the present invention have been described using embodiments, the present invention is not limited to the embodiments and various modifications and substitutions can also be made without departing from the scope and spirit of the present invention.

What is claimed is:

1. A driver state detection device comprising:
a recognizer configured to recognize a monitoring direction of a driver of a mobile object and a behavior of the mobile object;
a determiner configured to determine whether or not the monitoring direction of the driver recognized by the recognizer is appropriate;
a counter configured to perform a counting process for a period of time in which the determiner determines that the monitoring direction of the driver is inappropriate; and
an alert output configured to output alert information when a count value from the counter is greater than or equal to a threshold,
wherein the counter stops the counting process while the recognizer recognizes that the behavior of the mobile object is disturbed or resets the count value when the disturbance in the behavior of the mobile object is recognized.

2. The driver state detection device according to claim 1, wherein the determiner
determines whether or not the monitoring direction of the driver is appropriate based on the monitoring direction of the driver and a preset monitoring target area and
extends the monitoring target area when the recognizer recognizes that the behavior of the mobile object is disturbed.

3. The driver state detection device according to claim 1, wherein the counter performs the counting process when it is determined that the monitoring direction is inappropriate even while the recognizer recognizes that the behavior of the mobile object is disturbed and resets the counting process when the disturbance in the behavior has subsided.

4. The driver state detection device according to claim 3, wherein the alert output suppresses the output of the alert information when the count value is greater than or equal to the threshold while the behavior is disturbed.

5. The driver state detection device according to claim 3, wherein the counter resets a count value that has been accumulated in the counting process when the recognizer recognizes that the behavior of the mobile object is disturbed and it is determined that the monitoring direction is inappropriate.

6. The driver state detection device according to claim 5, wherein the counter performs a reset process including a count value that has been accumulated in the counting process before the recognizer recognizes that the behavior of the mobile object is disturbed.

7. The driver state detection device according to claim 1, wherein the disturbance in the behavior is disturbance in the behavior of the mobile object in a lateral direction.

8. The driver state detection device according to claim 1, further comprising a movement controller configured to control movement of the mobile object,
wherein the recognizer recognizes that the behavior of the mobile object is disturbed when control for stabilizing the behavior of the mobile object is executed by the movement controller.

9. The driver state detection device according to claim 1, wherein the disturbance in the behavior includes an avoidance operation including lateral movement of the mobile object based on a driving operation of the driver according to an external situation of the mobile object.

10. A driver state detection method comprising:
recognizing, by a computer, a monitoring direction of a driver of a mobile object and a behavior of the mobile object;
determining, by the computer, whether or not the recognized monitoring direction of the driver is appropriate;
performing, by the computer, a counting process for a period of time in which it is determined that the monitoring direction of the driver is inappropriate;
outputting, by the computer, alert information when a count value from the counter is greater than or equal to a threshold and
stopping, by the computer, the counting process while it is recognized that the behavior of the mobile object is disturbed or resetting the count value when the disturbance in the behavior of the mobile object is recognized.

11. A computer-readable non-transitory storage medium storing a program for causing a computer to:
recognize a monitoring direction of a driver of a mobile object and a behavior of the mobile object;
determine whether or not the recognized monitoring direction of the driver is appropriate;
perform a counting process for a period of time in which it is determined that the monitoring direction of the driver is inappropriate;
output alert information when a count value from the counter is greater than or equal to a threshold; and
stop the counting process while it is recognized that the behavior of the mobile object is disturbed or reset the count value when the disturbance in the behavior of the mobile object is recognized.
